(19) United States
(12) Patent Application Publication
(10) Pub. No.: US 2018/0287232 A1
(43) Pub. Date: Oct. 4, 2018

(54) BATTERY SYSTEM

(71) Applicant: Robert Bosch GmbH, Stuttgart (DE)

(72) Inventors: Jens-Martin Koegel, Stuttgart (DE); Benjamin Kopp, Remseck Am Neckar (DE)

(21) Appl. No.: 15/938,249

(22) Filed: Mar. 28, 2018

(30) Foreign Application Priority Data
Mar. 30, 2017 (DE) 10 2017 205 410.7

(51) Int. Cl. H01M 10/6556; B60K 1/04; H01M 2/10; H01M 10/613; H01M 10/625; H01M 2/20

(52) U.S. Cl. CPC H01M 10/6556; B60K 1/04; H01M 2/1077; H01M 2220/20; H01M 10/625; H01M 2/206; H01M 10/613

(57) ABSTRACT

A battery system (5) comprising at least one battery module (10) with at least one battery cell (2), and a cooling unit (20) with a duct structure (22) through which a coolant is able to flow and which has at least one inlet (24) and at least one outlet (26). The duct structure has at least one hollow-cylindrical pipe element bent in a U shape, and the duct structure passes through at least one lamella.

### BACKGROUND OF THE INVENTION

The invention relates to a battery system which comprises at least one battery module with at least one battery cell, and a cooling unit with a duct structure through which a coolant is able to flow and which has at least one inlet and at least one outlet.

It is clear that battery systems will be used increasingly often in future in particular in vehicles such as electric vehicles (EV), hybrid vehicles (HEV) or plug-in hybrid vehicles (PHEV) and also in stationary installations and in consumer electronic products, said battery systems being subject to stringent requirements in terms of reliability, efficiency, safety and lifetime. For such applications, battery systems with lithium-ion battery cells are suitable in particular. These are distinguished, inter alia, by high energy densities, thermal stability and extremely low self-discharge.

Battery cells convert chemical reaction energy into electrical energy. In this case, a battery cell has a positive terminal and a negative terminal for making electrical contact. A plurality of battery cells can be combined and electrically interconnected. To this end, the terminals of the battery cells are interconnected by means of cell connectors. Battery cells interconnected in series or parallel can be combined to form a battery module.

Battery cells are able to be operated optimally in defined temperature ranges. Therefore, the battery cells of a battery module are generally connected to a thermal management system. The thermal management system heats the battery cells at low temperatures and cools the battery cells at high temperatures. In particular, during operation, cooling of the battery cells is necessary, since the individual battery cells heat up during operation.

The document DE 10 2011 109 213 A1 discloses a battery having a plurality of individual battery cells which are electrically interconnected. The battery cells are in that case arranged on a heat-conducting plate through which a coolant flows. To that end, the heat-conducting plate has a duct structure which comprises, inter alia, an inlet opening and an outlet opening.

A duct structure for cooling systems is known from the document US 2014/0262189 A1. The duct structure comprises interconnected pipe elements. In that case, the duct structure is configured in a meandering manner and has straight pipe elements and pipe elements bent in a U shape. The duct structure passes through a plurality of flat lamellae.

U.S. Pat. No. 5,960,866 A discloses a cooling unit having transfer pipes for dissipating heat from electronic components, and a method for the production thereof. The cooling unit comprises a plate-like metal block produced in particular from aluminum, said metal block being passed through by heat transfer pipes. In that case, the heat transfer pipes preferably have a circular cross section.

### SUMMARY OF THE INVENTION

A battery system is proposed which comprises at least one battery module with at least one battery cell, and a cooling unit with a duct structure through which a coolant is able to flow and which has at least one inlet and at least one outlet. The cooling unit serves in particular to dissipate heat that arises during operation of the battery module and thus to cool the battery module.

Provision is made according to the invention for the duct structure of the cooling unit to have at least one hollow-cylindrical pipe element bent in a U shape, and for the duct structure of the cooling unit to pass through at least one lamella of the cooling unit.

The pipe element, bent in a U shape, of the duct structure in this case preferably has an annular cross section. However, other cross sections, for example oval, are also conceivable. The pipe element bent in a U shape has for example a region which is configured in the form of half a torus, i.e. in the form of a segment of a torus, which extends through an angular range of 180°. The lamella of the cooling unit is manufactured for example from a flat metal sheet and has bores for receiving the duct structure.

According to an advantageous development of the invention, the at least one lamella is configured in an L-shaped manner and has a base limb and a side limb. In particular, the side limb extends in this case at least approximately at right angles to the base limb. The side limb and the base limb can form for example an angle of more than 90° with one another.

In this case, the duct structure preferably passes through the base limb of the lamella, and the side limb of the lamella faces the battery module. The battery module can in this case rest directly against the side limb of the lamella, or a heat-conducting film or heat-conducting paste can be provided between the side limb and the battery module.

According to a further advantageous development of the invention, the at least one lamella is configured in a U-shaped manner and has a base limb, a side limb and an outer limb. The base limb is in this case arranged between the side limb and the outer limb. In particular, the side limb and the outer limb extend in this case parallel to one another and at right angles to the base limb arranged between them.

In this case, the duct structure preferably passes through the base limb of the lamella, and the side limb of the lamella faces the battery module. The battery module can in this case rest directly against the side limb of the lamella, or a heat-conducting film or heat-conducting paste can be provided between the side limb and the battery module. The side limb and the outer limb in this case surround the duct structure.

According to an advantageous configuration of the invention, the duct structure has at least one hollow-cylindrical, completely straight pipe element, which is connected to the at least one pipe element bent in a U shape. The completely straight pipe element of the duct structure in this case preferably has an annular cross section and is configured in a rotationally symmetrical manner.

Preferably, the at least one completely straight pipe element is connected to the at least one pipe element bent in a U shape by means of a Lok Ring. Other connecting techniques are likewise conceivable, for example welding or soldering.

A Lok Ring is a sleeve configured at least approximately in a hollow-cylindrical manner, preferably made of a metal material. An outside diameter of the pipe elements in this case corresponds to an inside diameter of the Lok Ring. During the production of the connection, the pipe elements to be connected are pushed into the Lok Ring from both sides. Subsequently, the Lok Ring is pressed onto the pipe elements in a radial direction from the outside. During the production of the connection, a pipe element may also be widened by twice the wall thickness, and the pipe elements to be connected are pushed one into the other with a precise fit. Subsequently, the Lok Ring is pushed over both pipe elements and the pipe elements and the Lok Ring are pressed together.

According to a further advantageous configuration of the invention, the duct structure has at least one hollow-cylindrical, sectionally straight pipe element, which is connected to the at least one pipe element bent in a U shape. The sectionally straight pipe element of the duct structure in this case preferably has an annular cross section. At least one section of the sectionally straight pipe element is in this case configured in a rotationally symmetrical manner.

Preferably, the at least one sectionally straight pipe element is connected to the at least one pipe element bent in a U shape by means of a Lok Ring. The configuration and manner of operation of the Lok Ring have already been described above.

A battery system according to the invention is advantageously used in an electric vehicle (EV), in a hybrid vehicle (HEV), in a plug-in hybrid vehicle (PHEV) or in a stationary application.

The battery system according to the invention allows comparatively good contact between the heat-generating battery module and the cooling unit for cooling the battery module. As a result, effective heat dissipation from the battery module by means of the cooling unit is ensured. Furthermore, the costs for producing the cooling unit and for assembling the battery system are advantageously reduced. Furthermore, the risk of coolant escaping as a result of leaks in the duct structure of the cooling unit is considerably reduced. In particular, a cost-effective and coolant-tight connection between individual pipe elements of the duct structure of the cooling unit can be achieved by means of Lok Rings.

### BRIEF DESCRIPTION OF THE DRAWINGS

Embodiments of the invention are explained in more detail with reference to the drawings and the following description.

In the drawings:

FIG. 1 shows a perspective illustration of a battery system,

FIG. 2 shows an exploded illustration of a cooling unit according to a first exemplary embodiment,

FIG. 3 shows a perspective illustration of the cooling unit in FIG. 2,

FIG. 4 shows an exploded illustration of a cooling unit according to a second exemplary embodiment,

FIG. 5 shows a perspective illustration of the cooling unit in FIG. 4, and

FIG. 6 shows a sectional illustration of a connection of two pipe elements by means of a Lok Ring.

### DETAILED DESCRIPTION

In the following description of the embodiments of the invention, identical or similar elements are denoted by identical reference signs, wherein a repeated description of these elements will be dispensed with in individual cases. The figures depict the subject matter of the invention only schematically.

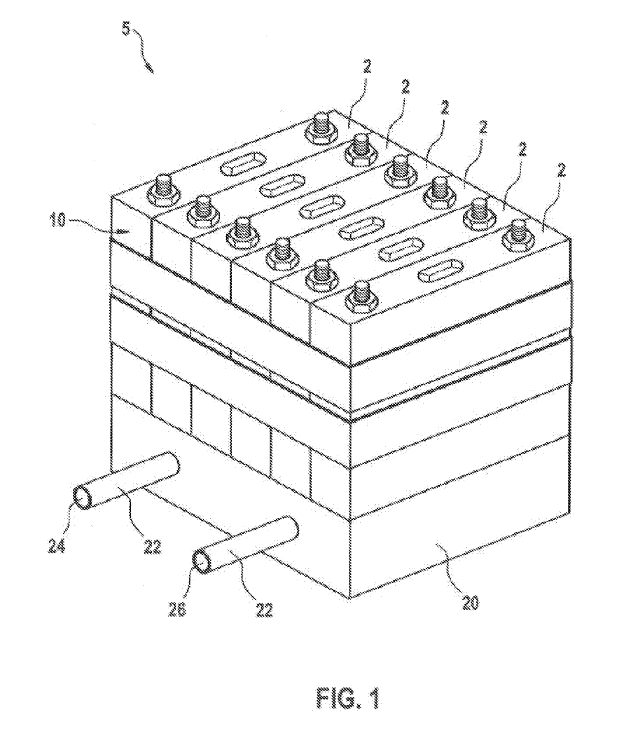

FIG. 1 shows a perspective illustration of a battery system 5. The battery system 5 comprises a battery module 10 and a cooling unit 20 in the present case. The battery module 10 rests against the cooling unit 20 and is in thermal contact with the cooling unit 20. The battery module 10 comprises six battery cells 2 in the present case. The battery system 5 can also have a plurality of battery modules 10. Likewise, each battery module 10 can also have a different number of battery cells 2.

The cooling unit 20 serves in particular to dissipate heat that arises during operation of the battery module 10 and thus to cool the battery module 10. During operation, a duct structure 22 of the cooling unit 20 is flowed through by a coolant. To this end, the duct structure 22 has an inlet 24, through which the coolant flows into the duct structure 22, and an outlet 26, through which the coolant flows out of the duct structure 22.

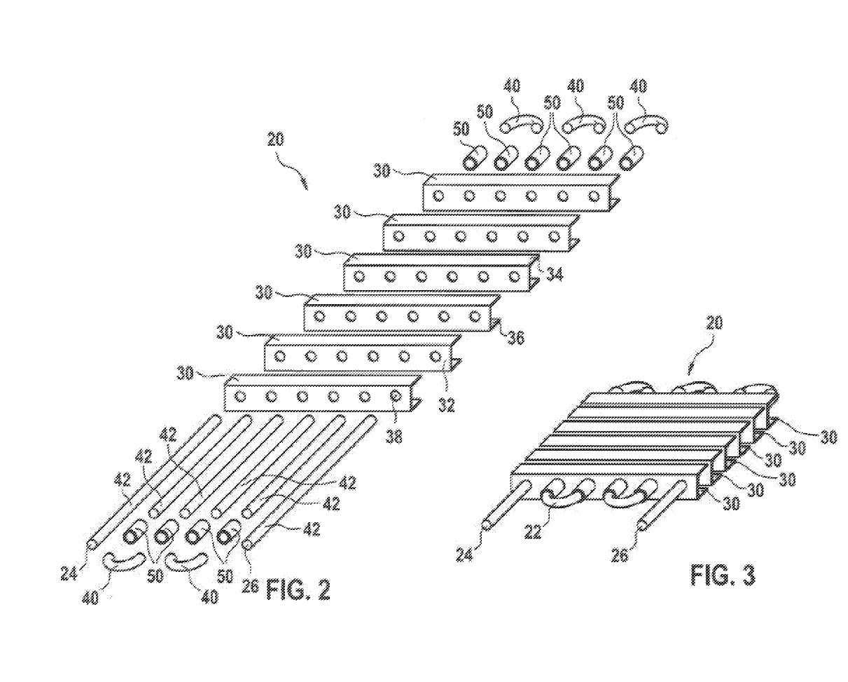

FIG. 2 shows an exploded illustration of a cooling unit 20 of the battery system 5 shown in FIG. 1, according to a first exemplary embodiment. The cooling unit 20 according to the first exemplary embodiment comprises a plurality of completely straight pipe elements 42 that extend parallel to one another. The completely straight pipe elements 42 have an annular cross section and are configured in a rotationally symmetrical manner.

The cooling unit 20 according to the first exemplary embodiment also comprises a plurality of pipe elements 40 bent in a U shape. The pipe elements 40 bent in a U shape likewise have an annular cross section. The pipe elements 40 bent in a U shape are configured in the present case in the form of a segment of a torus, which extends through an angular range of 180°.

In each case two completely straight pipe elements 42 located alongside one another are connected to a pipe element 40 bent in a U shape. In the present case, the completely straight pipe elements 42 are connected to the pipe elements 40 bent in a U shape by means of Lok Rings 50. However, other types of connection of the pipe elements 40, 44, for example by welding, soldering, adhesive bonding or screwing, are also conceivable. A completely straight pipe element 42 located at one edge has the inlet 24 at one end. A completely straight pipe element 42 located at another edge has the outlet 26 at one end.

The cooling unit 20 according to the first exemplary embodiment furthermore comprises a plurality of lamellae 30. The lamellae 30 are configured in a U-shaped manner in the present case and each have a base limb 32, a side limb 34 and an outer limb 36. The base limb 32 is in this case arranged between the side limb 34 and the outer limb 36. In this case, the side limb 34 and the outer limb 36 extend parallel to one another and at right angles to the base limb 32 arranged between them. The lamellae 30 are manufactured from a flat metal sheet.

Introduced into the base limb 32 of the lamellae 30 are a plurality of bores 38. The bores 38 have a diameter which corresponds to an outside diameter of the completely straight pipe elements 42. The completely straight pipe elements 42 are guided through the bores 38 and thus pass through the base limbs 32 of the lamellae 30.

FIG. 3 shows a perspective illustration of the cooling unit in FIG. 2. The interconnected completely straight pipe elements 42 and pipe elements 40 bent in a U shape form the duct structure 22. The duct structure 22 is configured in a snake-like or meandering manner and passes through the lamellae 30 multiple times.

The lamellae 30 are arranged such that the side limbs 34 of the lamellae face in the same direction and are located alongside one another. In the battery system 5, the side limbs 34 face the battery module 10, which rests against the side limbs 34 and is in thermal contact therewith.

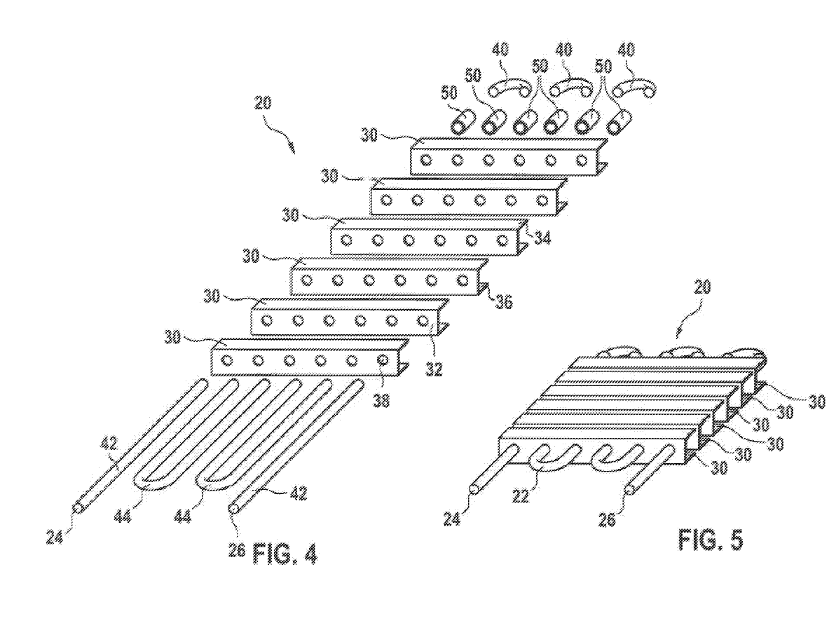

FIG. 4 shows an exploded illustration of a cooling unit 20 of the battery system 5 shown in FIG. 1, according to a second exemplary embodiment. The cooling unit 20 according to the second exemplary embodiment comprises two completely straight pipe elements 42 that extend parallel to one another, and a plurality of sectionally straight pipe elements 44. The completely straight pipe elements 42 have an annular cross section and are configured in a rotationally symmetrical manner.

The sectionally straight pipe elements 44 likewise have an annular cross section. The sectionally straight pipe elements 44 each have a central region which is configured in the form of a segment of a torus, which extends through an angular range of 180°. The central region is adjoined by two straight sections, which extend parallel to one another and which are configured in a rotationally symmetrical manner.

The cooling unit 20 according to the second exemplary embodiment in this case also comprises a plurality of pipe elements 40 bent in a U shape. The pipe elements 40 bent in a U shape likewise have an annular cross section. The pipe elements 40 bent in a U shape are configured in the present case in the form of a segment of a torus, which extends through an angular range of 180°.

In each case two sectionally straight pipe elements 44 that are located alongside one another are connected to a pipe element 40 bent in a U shape. In the present case, the sectionally straight pipe elements 44 are connected to the pipe elements 40 bent in a U shape by means of Lok Rings 50. However, other types of connection of the pipe elements 40, 44, for example by welding, soldering, adhesive bonding or screwing, are also conceivable.

Likewise, the completely straight pipe elements 42 are each connected to a pipe element 40 bent in a U shape. A completely straight pipe element 42 located at one edge has the inlet 24 at one end. A completely straight pipe element 42 located at another edge has the outlet 26 at one end.

The cooling unit 20 according to the second exemplary embodiment furthermore comprises a plurality of lamellae 30. The lamellae 30 are configured in a U-shaped manner in the present case and each have a base limb 32, a side limb 34 and an outer limb 36. The base limb 32 is in this case arranged between the side limb 34 and the outer limb 36. In this case, the side limb 34 and the outer limb 36 extend parallel to one another and at right angles to the base limb 32 arranged between them. The lamellae 30 are manufactured from a flat metal sheet.

Introduced into the base limb 32 of the lamellae 30 are a plurality of bores 38. The bores 38 have a diameter which corresponds to an outside diameter of the completely straight pipe elements 42 and of the sectionally straight pipe elements 44. The completely straight pipe elements 42 and the sectionally straight pipe elements 44 are guided through the bores 38 and thus pass through the base limbs 32 of the lamellae 30.

FIG. 5 shows a perspective illustration of the cooling unit in FIG. 4. The interconnected completely straight pipe elements 42, sectionally straight pipe elements 44 and pipe elements 40 bent in a U shape form the duct structure 22. The duct structure 22 is configured in a snake-like or meandering manner and passes through the lamellae 30 multiple times.

The lamellae 30 are arranged such that the side limbs 34 of the lamellae face in the same direction and are located alongside one another. In the battery system 5, the side limbs 34 face the battery module 10, which rests against the side limbs 34 and is in thermal contact therewith.

In the first exemplary embodiment shown here and in the second exemplary embodiment, the lamellae 30 are each configured in a U-shaped manner. The lamellae 30 can also be configured in some other way, for example in an L-shaped manner. In this case, the lamellae 30 do not have an outer limb 36, but only a base limb 32 and a side limb 34. The side limbs 34 in this case extend at right angles to the base limbs 32 and face the battery module 10.

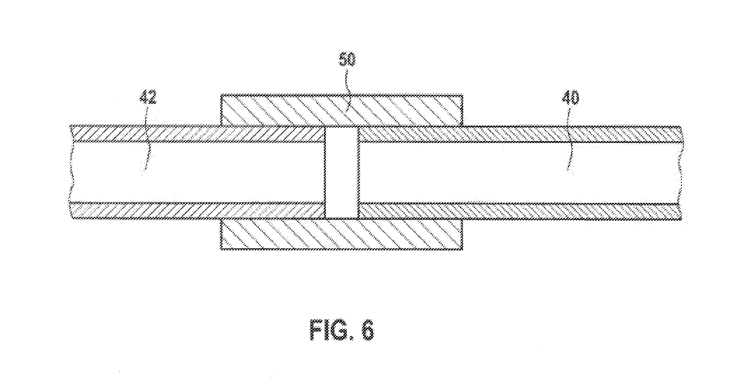

FIG. 6 shows a sectional illustration of a connection of a completely straight pipe element 42 to a pipe element 40 bent in a U shape by means of a Lok Ring 50. The Lok Ring 50 is a sleeve configured in a hollow-cylindrical manner and manufactured from a metal material. Instead of the completely straight pipe element 42, a sectionally straight pipe element 44 can also be connected to the pipe element 40 bent in a U shape in the same way by means of the Lok Ring 50.

The outside diameter of the completely straight pipe element 42 corresponds to an outside diameter of the pipe element 40 bent in a U shape. The outside diameter of the pipe elements 40, 42 corresponds to an inside diameter of the Lok Ring 50.

During the production of the connection, the pipe elements 40, 44 to be connected are pushed into the Lok Ring 50 in an axial direction from both sides. Subsequently, the Lok Ring 50 is pressed onto the pipe elements 40, 44 in a radial direction from the outside.

The invention is not limited to the exemplary embodiments described here and the aspects highlighted therein. Rather, a large number of modifications which are within the scope of practice of a person skilled in the art are possible within the scope specified by the claims.

1. A battery system (5) comprising
at least one battery module (10) with at least one battery cell (2), and
a cooling unit (20) with a duct structure (22) through which a coolant is able to flow and which has at least one inlet (24) and at least one outlet (26),
wherein the duct structure (22) has at least one hollow-cylindrical pipe element (40) bent in a U shape, and
wherein the duct structure (22) passes through at least one lamella (30).

2. The battery system (5) according to claim 1, wherein the at least one lamella (30) is configured in an L-shaped manner and has a base limb (32) and a side limb (34).

3. The battery system (5) according to claim 2, wherein the duct structure (22) passes through the base limb (32), and wherein the side limb (34) faces the battery module (10).

4. The battery system (5) according to claim 1, wherein the at least one lamella (30) is configured in a U-shaped manner and has a base limb (32), a side limb (34) and an outer limb (36).

5. The battery system (5) according to claim 4, wherein the duct structure (22) passes through the base limb (32), and wherein the side limb (34) faces the battery module (10).

6. The battery system (5) according to claim 1, wherein the duct structure (22) has at least one hollow-cylindrical, completely straight pipe element (42), which is connected to the at least one pipe element (40) bent in a U shape.

7. The battery system (5) according to claim 6, wherein the at least one completely straight pipe element (42) is connected to the at least one pipe element (40) bent in a U shape by means of a Lok Ring (50).

8. The battery system (5) according to claim 1, wherein the duct structure (22) has at least one hollow-cylindrical, sectionally straight pipe element (44), which is connected to the at least one pipe element (40) bent in a U shape.

9. The battery system (5) according to claim 8, wherein the at least one sectionally straight pipe element (44) is connected to the at least one pipe element (40) bent in a U shape by means of a Lok Ring (50).

10. A vehicle comprising a battery system (5) according to claim 1.

11. The vehicle according to claim 10, wherein vehicle is an electric vehicle (EV), a hybrid vehicle (HEV), or a plug-in hybrid vehicle (PHEV).
